(19) United States
(12) Patent Application Publication
(10) Pub. No.: US 2022/0048194 A1
(43) Pub. Date: Feb. 17, 2022

(54) INDUSTRIAL ROBOT APPARATUS WITH IMPROVED TOOLING PATH GENERATION, AND METHOD FOR OPERATING AN INDUSTRIAL ROBOT APPARATUS ACCORDING TO AN IMPROVED TOOLING PATH

(71) Applicant: Nuovo Pignone Tecnologie - s.r.l., Florence (IT)

(72) Inventors: Lorenzo BIANCHI, Florence (IT); Francescosaverio CHIARI, Florence (IT); Stefano RICCI, Florence (IT); Massimo GUERRINI, Florence (IT); Stefano COSTANTINO, Florence (IT); Fabio LEONI, Florence (IT)

(21) Appl. No.: 17/310,127

(22) PCT Filed: Jan. 17, 2020
(86) PCT No.: PCT/EP2020/025019

§ 371 Date: Jul. 19, 2021

(30) Foreign Application Priority Data
Jan. 23, 2019 (IT) 102019000000995

(51) Int. Cl. B25J 9/16; B25J 19/02

(52) U.S. Cl. CPC B25J 9/1684; B25J 19/022; B25J 9/1694

(57) ABSTRACT

An apparatus for performing an industrial working operation on a workpiece comprises: an anthropomorphous robot comprising an end effector including a 2D laser scanner and a working tool; an RTOS computer; and a robot controller. The computer provides successive positional data along a scanning path to robot controller, and a synchronization signal directly to input port of the 2D laser scanner, thereby commanding successive scanning operations on the workpiece in synchronism with successive poses of the end effector, to acquire 3D shape information about the workpiece. The working tool is operated while the end effector is subsequently moved along a tooling path and/or is moved along a combined scanning and tooling path. An apparatus for acquiring a shape of an object arranged at a working area and methods are further disclosed.

### TECHNICAL FIELD

The present disclosure relates to robot working of workpieces, in particular to robot welding. Embodiments disclosed herein specifically concern an industrial robot, in particular a robot welding apparatus, and more specifically an anthropomorphous robot provided with a 2D laser scanner at the end-effector. Also disclosed herein is a method for operating such an industrial robot (robot welding apparatus), as well as an apparatus and method for acquiring a shape by an industrial robot.

Hereinafter, for the sake of brevity robot welding will be mostly referred to as an exemplary but not limiting example of robot working.

### BACKGROUND ART

Nowadays, automatic or robotized working operations, notably welding operations, require very accurate knowledge of the 3D trajectory or tooling path, specifically welding path, and need very accurate mechanical structures and actuation systems in order to handle the working tool, specifically the welding torch, along the 3D trajectory or tooling path with the greatest precision.

The tooling path may have been designed onto a sample piece, while the actual workpiece may have a slightly different shape.

Furthermore, the ability to precisely follow the welding paths or trajectories is essential in order to take thermal effects into account, e.g. on very thin steel layers of critical parts of aero-spatial mechanical structures; thermal effect, indeed, could lead to an alteration of the original geometry of the object to be welded. Therefore, considering that aero-spatial mechanical components could include several welding paths on the same part, it is of great importance to take as accurate 3D measurements of the shape of the object as possible, before and/or after each welding operation, so as to accurately adjust the welding path each time is required.

A similar problem arises in the case of multi-layer coating of workpieces, wherein the 3D shape of the workpiece slightly changes after each layer has been coated, as well as in other applications.

Moreover, said aero-spatial mechanical components and other workpieces are complex 3D structures, and the related welding (or generally tooling) trajectories similarly have complex 3D paths.

Very precise 3D shapes can generally be acquired—so that very precise 3D paths can generally be extracted therefrom—by using known 2D laser scanners appropriately.

Most of known 2D laser scanners use the triangulation principle to acquire (through a suitable camera) an accurate 2D image of a laser line formed at the intersection of the workpiece outer surface with the laser scanning plane (e.g. provided by suitably sweeping a laser beam emitted by a laser projector) in one given mutual position thereof.

In order to acquire a 3D image of the workpiece shape, 2D laser scanners have to be put into relative motion—along scanning line trajectories or scanning paths that provide the third dimension or coordinate of each point of the laser line—with respect to the part to be scanned while successive 2D images are taken; the 3D shape may then be reconstructed from the 3D point cloud.

In known arrangements, a conveyor belt moves the workpiece towards a fixed 2D laser scanner, or conversely the workpiece is stationary and the 2D laser scanner is supported by a carriage movable along a rail, and the successive 2D images are taken at regular time intervals. In order to account for inconstant mutual speed and other irregularities of the linear motion, such as acceleration and deceleration phases at the beginning and at the end of the scanning path, an encoder may be used to provide correct synchronization over time between the successive laser line acquisitions and the successive mutual positions of workpiece and scanner, i.e. to provide correct information in the third dimension.

However, the 3D complexity, the quite unusual small-scale manufacturing, and the possibly large size of said aero-spatial mechanical components do not allow the above arrangements.

It is known in the art to address these issues by using anthropomorphic robotic arms which mount, as an end-effector, an assembly comprising—besides a welding torch or other tool—a 2D laser scanner: the 3D shape of the workpiece may be acquired by moving the 2D laser scanner with respect to a stationary workpiece while acquiring successive 2D images.

The 2D laser scanner is thus suitable to view the welding pool or in general the working area; said 2D laser scanner therefore allows to have up-to-date information about the shape of the workpiece or the relevant part thereof, as the shape changes e.g. for thermal effects or due to newly coated layers.

The six degrees of freedom of the robot anthropomorphic arm may be exploited to obtain the linear relative motion between 2D laser camera and workpiece along a rectilinear scanning path, or an even more complex scanning path.

However, the problem of having an accurate knowledge of the actual position on the 3D shape at which each 2D image is taken is exacerbated, and there is no possibility of using a linear motion encoder because a conveyor belt or rail system is not present for supporting it.

While a stop-and-go approach could be used to overcome the negative effect of inconstant speed and other irregularities of the robot arm motion, it is too slow to be practically implemented on a real industrial scenario.

Accordingly, an improved apparatus including an industrial anthropomorphic robot, specifically a welding robot, and a method for performing robot working, specifically robot welding, with an efficient and up-to-date acquisition of accurate 3D scanning data to address the issues of accounting for changes of the workpiece shape during working operations would be beneficial and would be welcome in the technology.

More in general, it would be desirable to provide methods and systems adapted to more efficiently acquire accurate shapes of large and/or delicate workpieces or other objects.

### SUMMARY

In one aspect, the subject matter disclosed herein is directed to an apparatus configured to perform an industrial working operation on a workpiece arranged at a working area. The apparatus comprises an anthropomorphous robot movable in space at working area, a computer, and a robot controller. The anthropomorphous robot comprises an end effector including a 2D laser scanner and a working tool which is able to perform said working operation on the workpiece. The 2D laser scanner comprises a laser projector, a camera, to and an input port. The robot controller is configured to make the robot move the end effector along a path, the working tool being selectively operable during the movement. The computer is provided with a Real-Time Operating System and is operatively connected to the robot controller and to the input port of the 2D laser scanner. The computer is configured to provide successive positional data along a scanning path to the robot controller, and a synchronization signal directly to the input port of the 2D laser scanner, thereby commanding successive scanning operations on the workpiece in synchronism with successive poses of the end effector along the scanning path, to acquire 3D shape information about the workpiece. The working tool is configured to be operated while the end effector is subsequently moved along a tooling path and/or is moved along said scanning path thus defining a combined scanning and tooling path.

In another aspect, the subject matter disclosed herein is directed to a method for performing an industrial working operation on a workpiece arranged at a working area. The method includes a step of acquiring 3D shape information about the workpiece by operating the computer with a Real-Time Operating System to provide successive positional data along a scanning path to the robot controller, and to provide a synchronization signal directly to the input port of the 2D laser scanner; and by operating the robot controller to move the end effector along the scanning path, thereby performing successive scanning operations in synchronism with successive poses of the end effector. The method further includes a step of subsequently operating the robot controller to move the end effector along a tooling path different from the scanning path and operating the working tool while moving the end effector along the tooling path; or operating the working tool while moving the end effector along the scanning path, thus defining a combined scanning and tooling path.

In the above aspects, the arrangement of the camera at the end effector of the anthropomorphic robot advantageously allows the workpiece to be kept stationary—although this is not strictly necessary—and advantageously allows highest resolution in profile or shape data acquisition, and thus maximum accuracy of the 3D tooling path, exactly matching the robot moving capabilities—namely the finest displacement provided by the robotic arm—to be achieved.

Advantageously, synchronism in the acquisition of the three coordinates of the 3D points of the cloud is obtained by use of the Real Time Operating System and of the synchronization signal, dispensing with the need for an external encoder.

Advantageously, an update of 3D tooling paths during subsequent working processes on a same workpiece is easily achieved.

Moreover, new 3D shape data may also be acquired by the same components during a working process, e.g. for quality control.

In another aspect, the subject matter disclosed herein is directed to an apparatus configured to acquire a shape of an object arranged at a working area. The apparatus comprises an anthropomorphous robot movable in space at working area, a computer, and a robot controller. The anthropomorphous robot comprises an end effector including a 2D laser scanner. The 2D laser scanner comprises a laser projector, a camera, and an input port. The robot controller is configured to make the robot drive the 2D laser scanner along a scanning path. The computer is provided with a Real-Time Operating System and is operatively connected to the robot controller and to the input port of the 2D laser scanner. The computer is configured to provide successive positional data along the scanning path to the robot controller, and a synchronization signal directly to the input port of the 2D laser scanner, thereby commanding successive scanning operations on the object in synchronism with successive poses of the end effector along the scanning path.

In another aspect, the subject matter disclosed herein is directed to a method for acquiring 3D shape information of an object arranged at a working area. The method includes a step of operating the computer with a Real-Time Operating System to provide successive positional data along a scanning path to the robot controller, and to provide a synchronization signal directly to the input port of the 2D laser scanner; and a step of operating the robot controller to move the end effector along the scanning path, thereby performing successive scanning operations in synchronism with successive poses of the end effector.

### BRIEF DESCRIPTION OF DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic view of an embodiment of an industrial robot apparatus,

FIG. 2 is a flowchart relating to a method for performing a working operation with the robot apparatus of FIG. 1,

FIG. 3 is a flowchart relating to a method for acquiring the shape of a workpiece with the robot apparatus of FIG. 1, and

FIG. 4 is a flowchart relating to a method for operating the robot apparatus of FIG. 1 according to an improved tooling path.

### DETAILED DESCRIPTION OF EMBODIMENTS

According to an aspect, the present subject-matter is directed to apparatus and methods for improving the generation of the tooling path that has to be followed by a robot tool. Specifically, in embodiments disclosed herein, an industrial anthropomorphic robot is used to perform an industrial working operation, such as a welding or coating operation, onto workpieces, such as mechanical parts. The arm of the industrial anthropomorphic robot has joints that allow its end effector, that includes the working tool, to move in space along a desired tooling path. The tooling path may have been designed onto a sample piece, while the actual workpiece may have a slightly different shape, and so the desired tooling path may also be slightly different. Moreover, each operation may comprise several passes on a same workpiece, and the shape of the workpiece may change from one pass to the next one, so that the tooling path may also change from one pass to the next one.

To acquire the actual shape of the workpiece, over which the tooling path is computed or adjusted, the robot arm is provided with a 2D laser scanner at the end effector. The robot arm takes a 2D image of the workpiece at each pose while it is moved into successive poses to provide the third dimension, so that the 3D shape of the workpiece may be reconstructed from the assembly of the 2D data from each image paired with the position at which it has been taken. The workpiece need not be moved, what is of importance in several cases. A computer provided with a Real Time Operating System is used to control the robot arm at least during the scanning movement and to command the taking of the images, thus guaranteeing, through a synchronization signal, that each image is taken only after the intended pose has actually been reached, therefore guaranteeing that each point of the 3D point cloud has consistent data, irrespectively of the speed of movement and of any irregularities of that movement. Once the shape of the workpiece has been acquired, the tooling path of a next working operation is computed or adjusted to the actual shape, that might have changed e.g. by thermal effects due to a previous welding operation. Because the 2D laser scanner is borne by the same robot arm end effector that bears the working tool, the resolution of the reconstructed 3D shape and therefore of the tooling path defined on that shape automatically matches the actual capability of the robot arm to follow that tooling path: neither computational efforts are wasted in reconstructing the shape with a higher resolution than that at which the working will be performed, nor there is the need to interpolate further positions for the working tool along a tooling path computed with a lower resolution; accordingly the accuracy is the highest possible.

During a tooling operation, further images may also be taken, again in synchronism with the successive poses of the robot arm along what becomes a combined scanning and tooling path.

According to a more general aspect, the subject-matter disclosed herein is directed to systems and methods for accurately acquiring the shape of an object by a robot apparatus. The robot apparatus bears a 2D laser scanner operated as stated above through a computer running a Real Time Operating System. The acquired shape is used for any desired purpose.

Reference now will be made in detail to embodiments of the disclosure, one or more examples of which are illustrated in the drawings. Each example is provided by way of explanation of the disclosure, not limitation of the disclosure. Instead, the scope of the invention is defined by the appended claims.

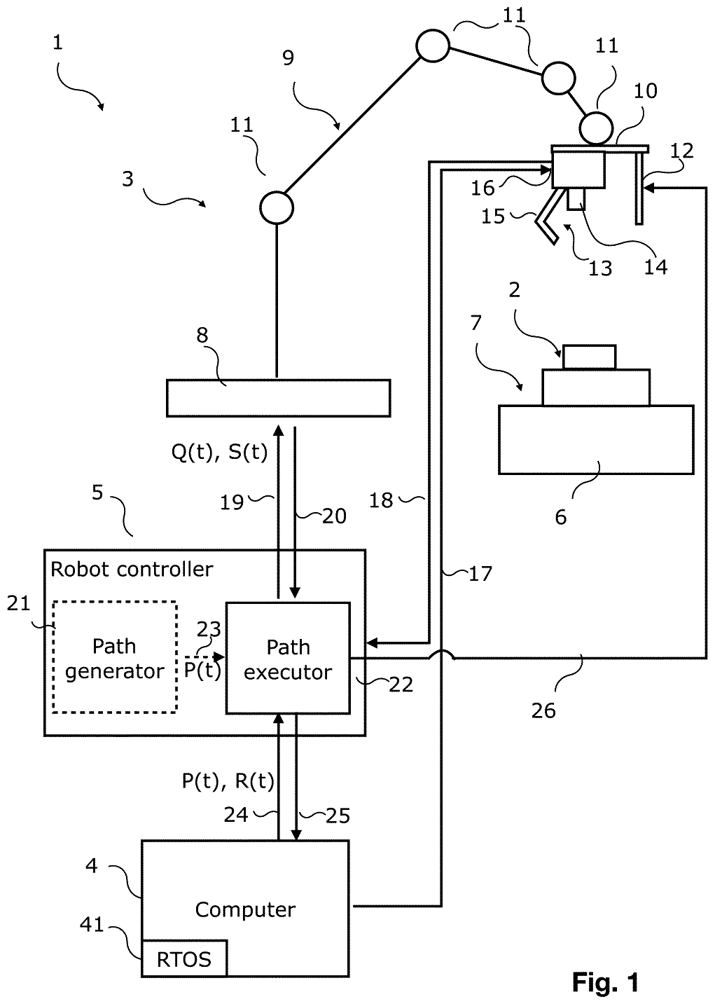

FIG. 1 schematically shows a first embodiment of an apparatus 1 for performing industrial working operations, notably welding, on workpieces, one exemplary workpiece 2 being shown, said apparatus 1 comprising an anthropomorphous robot 3 movable in space, a computer 4, and a robot controller 5 which are operatively connected as detailed below. A platform 6 supporting said workpiece 2 and defining a working area 7 is also shown, although it is not strictly necessary. The workpiece 2 can for example include very thin steel layers of critical parts of turbo-machineries. It should be understood that while the controller 5 has been shown separate from the robot 3, it may also be included thereinto, e.g. within base 8.

For reasons that will become clear below, computer 4 is provided with a Real Time Operating System (RTOS) 41.

The robot 3 comprises in a well know manner a base 8 and an arm 9 extending from and rotationally coupled with the base 8, whose end remote from the base 8 is termed hand or end effector 10. Several joints 11 are provided along the arm 9, four being shown by way of an example.

The end effector 10 is provided with a working tool 12, notably a welding torch. When the working tool 12 is a welding torch, it is able to provide heat for melting metal in order to provide a desired welding of the workpiece 2, e.g. of two metal components thereof; in other cases, the working tool is able to perform the intended working operation on the workpiece 2, e.g. emitting a paint for coating, emitting a glue for gluing etc.

The end effector 10 is also provided with a 2D laser scanner 13. The 2D laser scanner 13 comprises, in a well-known manner, a laser projector 14 and a camera 15 mutually angled.

The 2D laser scanner 13 comprises an input port 16 for receiving a synchronization signal for controlling the generation of the laser line by laser projector 14 and the acquisition of successive images by camera 15. The signal provided at the input port 16 of the 2D laser scanner 13 may be regarded as an aperiodic signal comprising pulses each triggering an image acquisition. It should be noted that the input port 16 is commonly available on a 2D laser scanner, however it is designed to receive the synchronization signal from an encoder operatively connected to a conveyor belt or similar member that is commonly provided to move the workpieces with respect to the 2D laser scanner, when the latter is stationary, or operatively connected to a carriage moving on a rail to move the 2D laser scanner with respect to a stationary workpiece, as discussed above.

While in previously known robot apparatuses the input port of 2D laser scanner would be connected to the encoder, in the apparatus 1 the input port 16 of 2D laser scanner 13 is conversely connected to, and receives a signal from, computer 4 along synchronization signal connection 17.

A data connection 18 is provided between 2D laser scanner and controller 5 to allow the controller 5 to receive the acquired images. 2D laser scanner 13 may include a preprocessor of the images. Controller 5 may further include image processing means and/or memory means for buffering or storing the images (not shown in FIG. 1 for the sake of simplicity). Alternatively, controller 5 may simply forward the images to be processed elsewhere, such as to computer 4 or to a further remote computer. Alternatively, the received acquired images, possibly preprocessed, might be sent directly from 2D laser scanner 13 to computer 4 or remote computer along a suitable data connection (not shown).

Further data and signal connections 19, 20 are provided between robot controller 5 and the robot 3. Though being shown directed to/from the robot 3 in general, the data and signal carried on connection 19 are mainly intended for controlling the pose of its arm 9; connection 20 mainly carries a feedback signal on whether the pose has been reached.

More specifically, when robot controller 5 comprises, as is usually the case, computer program modules (software, hardware or firmware) implementing a path generator 21 and a path executor 22, data and signal connections 19, 20 are provided between robot path executor 22 and the robot 3. A further signal connection 23 is provided in such case from path generator 21 to path executor 22. It will be understood from the following description that path generator 21 is an optional component herein.

Further data and signal connections 24, 25 are provided between robot controller 5 and computer 4. More specifically, when robot controller 5 comprises path generator 21 and path executor 22, data and signal connections 24, 25 are provided between computer 4 and path executor 22. The data and signal carried on connection 24 are mainly intended for controlling the pose of robot 3, notably of its arm 9, as discussed below; connection 25 mainly carries a feedback signal on whether the pose has been reached.

A torch control line 26 is provided from controller 5 (specifically from path executor 22) to end effector 10 for signals driving the tool 12, e.g. its switching on and off, its power level in the case of a welding torch, and/or other variables. Alternatively, the working tool 12 might be directly controlled by computer 4 along a suitable connection (not shown).

The robot apparatus 1 operates as follows, and allows the methods discussed below to be implemented.

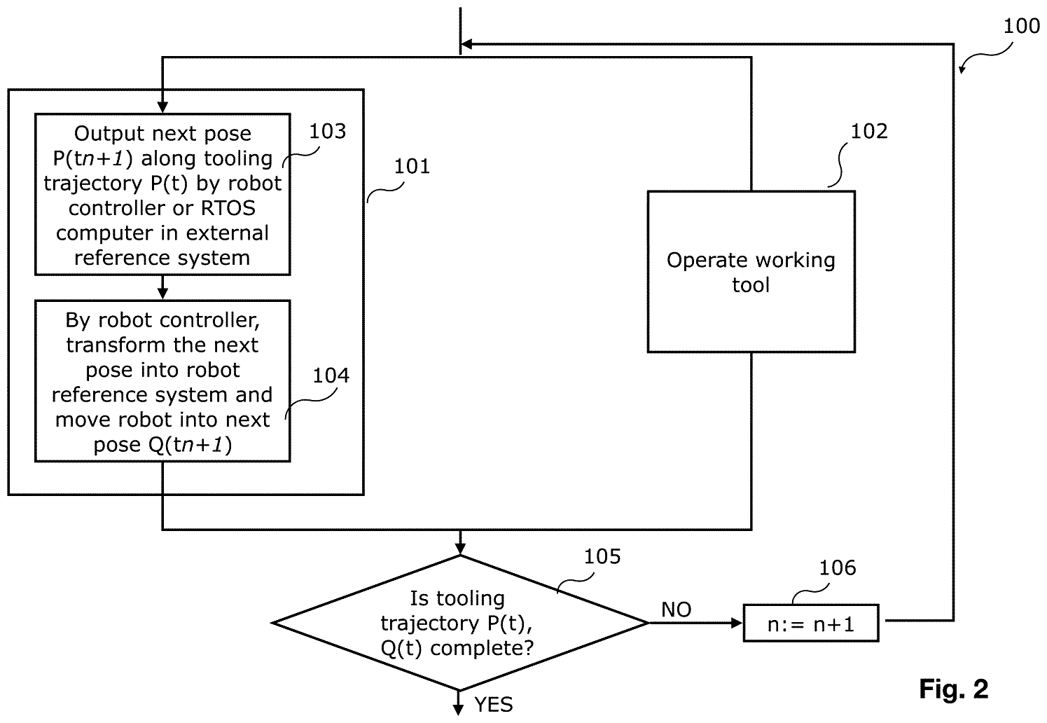

In a method 100 for welding or performing other working operations, as shown in the flowchart of FIG. 2 and as discussed with continued reference to FIG. 1, the robot controller 5 together with the computer 4 make the robot 3 move along a defined tooling trajectory or tooling path or welding path (step 101), and during such movement the torch or other working tool 12 is properly driven (step 102). The tooling path is the path that the robot 3, notably the end effector 10, should follow during operation of the working tool 12.

In greater detail, robot controller 5 and specifically its path executor 22 controls the position of the joints 11 of robot arm 9 through suitable actuators (not shown) so that the end effector 10 is overall provided with up to six degrees of freedom of movement in the space including and surrounding working area 7. The signal output by path executor 22 may be represented as a signal varying over time (though not being necessarily a signal continuous over time), wherein each value of the overall signal comprises multiple values in the robot internal coordinates, such as Q(t)=[q1(t),q2(t), . . . q6(t)] in the case of six degrees of freedom. Each quantity qi(tn) represents e.g. the angle that a specific joint 11 of arm 9 has to assume at a specific time tn, so that Q(tn) represents the pose of the end effector 10 at time tn, and the variation of the poses over time Q(t) expresses the path that is followed by the end effector 10. It is noted that here and below, italics notation is used for indexes.

The path that has to be followed by the end effector 10 is provided to path executor 22 of robot controller 5 in another system of spatial coordinates, usually in Cartesian coordinates, as P(t)=[x(t),y(t),z(t)], the task of path executor 22 being that of performing the spatial transformation. Instead of Cartesian coordinates, any other suitable spatial reference system may be used.

The path generator 21, that as previously mentioned is usually present in robot controller 5, may have the task of generating the path P(t) according to the desired working operation, the shape of the workpiece, its changes with respect to a sample piece, the speed of the tool, and other variables. As will be clear from the following description, moreover, the path P(t) may also be generated according to the changes of the shape of the workpiece due e.g. to thermal effects and/or other consequences of the working process being performed. It will be the path generator 21 that generates the path P(t) especially when the scanning data from 2D laser scanner 13 are processed by robot controller 5.

Alternatively, the latter task of generating the working or tooling path P(t) in the Cartesian space may be performed by computer 4, especially when the scanning data from 2D laser scanner 13 are processed by controller 4 or by an external computer, or when path generator 21 is missing.

The complete tooling path P(t) may be provided and transformed into tooling path Q(t) at once (it is noted that both P(t) and Q(t) are termed tooling path because they are different representations of the same entity), but preferably, in step 103 the robot controller 5, notably path generator 21, or the computer 4 outputs the next pose P(tn+1) along the tooling trajectory or path in the external reference system, and in step 104 the to robot controller 5, notably path executor 22, transforms the pose into the robot reference system Q(tn+1), and moves the end effector 10 to that pose.

Unless the desired tooling trajectory has been completed, as checked in step 105, the steps discussed above are thereafter repeated for a next pose, as indicated by the increment of index n in step 106. It should be understood that different methods of controlling the repetition of the steps than the method exemplified by steps 105, 106 may be equally used. It should also be understood that, if a control as that schematically shown is plainly used, then it might be necessary to add an additional “fake” start point or “fake” end point to the trajectory to ensure that the working is performed along the entire desired trajectory.

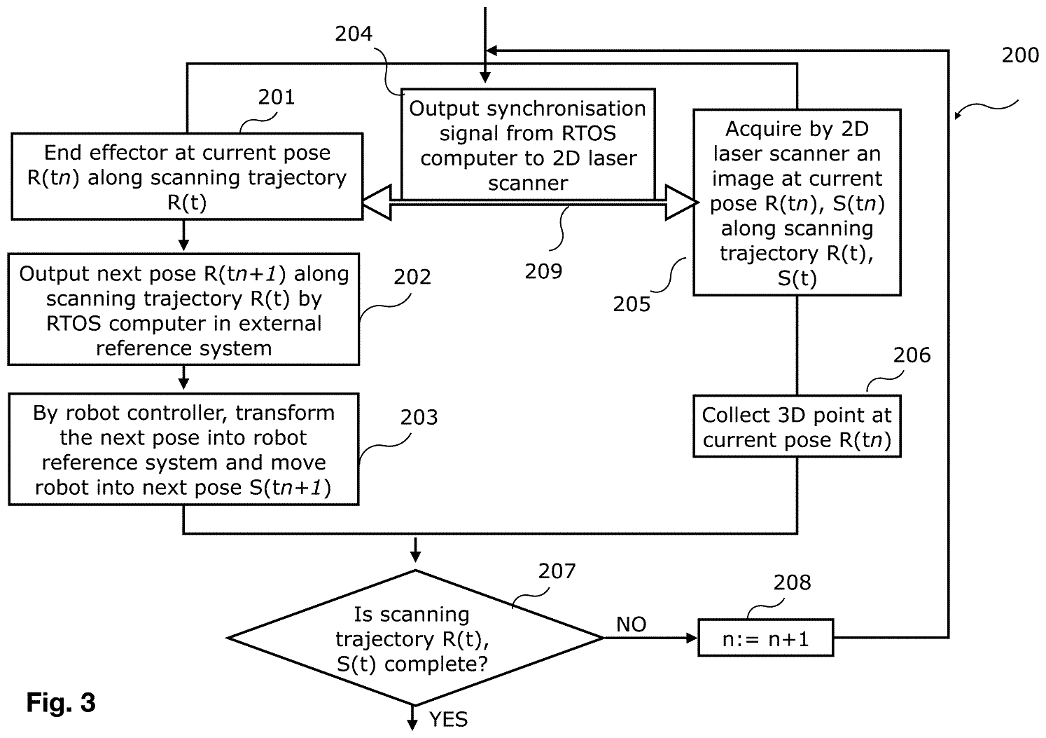

In a method 200 for acquiring the shape of a workpiece 2 that is described with reference to the flowchart of FIG. 3 as well as to FIG. 1, computer 4 running the RTOS 41 (in short, RTOS computer 4 hereinbelow) has the task of generating—possibly in addition to tooling path P(t) as discussed above—a scanning path R(t) in Cartesian coordinates or other spatial reference system, that is similarly transformed by path executor 22 into the robot coordinate system, e.g. as scanning path S(t)=[s1/(t),s2(t), . . . s6(t)]. It is noted that both R(t) and S(t) are termed scanning path because they are different representations of the same entity, namely the path that the robot 3, notably the end effector 10, should follow during operation of the 2D laser scanner 13.

Specifically, in step 201, the end effector 10 is at a current pose R(tn) along the scanning trajectory R(t). This may be ensured by computer 4, thanks to the RTOS 41 and/or possibly by a feedback along connections 20 and 25. Thereafter, in step 202, RTOS computer 4 outputs the next pose R(tn+1) along the scanning trajectory R(t), in the external coordinate system. In step 203, the pose R(tn+1) is transformed by path executor 22 of robot controller 5 into the robot coordinate system, e.g. as S(tn+1)=[s1(tn+1),s2(tn+1), . . . s6(tn+1)], and the end effector 10 is moved to such new pose.

While the end effector 10 is moved along the scanning path R(t), successive 2D images are taken by 2D laser scanner 13.

Specifically, in step 204, synchronization signal over connection 17 is controlled by RTOS computer 4, in particular its state is shortly changed to generate a trigger pulse, which is output not later than the output of the next pose R(tn+1) in step 202.

Based on the synchronization signal, specifically upon receipt of such pulse of the synchronization signal by 2D laser scanner 13 at its input port 16, in step 205 a 2D image is taken by 2D laser scanner 13. Thanks to the synchronization signal, it is ensured that the image is taken at the current pose R(tn) equivalent to S(tn).

In greater detail, the laser projector 14 emits a laser beam that is suitably swept in a laser plane (or shaped through suitable optics) to form, once it intercepts the outer surface of the workpiece 2, a scan line extending in a first direction. The camera 15 captures the light reflected by the surface of the workpiece 2 and, through the well-known triangulation principle, the distance of each surface point lying on the scan line is computed by the 2D laser scanner 13 itself or by a downstream component, notably robot controller 5 or computer 4, or even by an external computer. The computed distance, the position of the laser spot along the scan line, and the position of the scan plane—which in turn is dictated by the position of the end effector 10 along scanning path R(t)—provide a 3D point of the shape of workpiece 2, that is collected at step 206.

Steps 201 and 202 are shown as separate subsequent steps, and it will be understood that step 202 takes place immediately after, preferably as soon as possible after step 201, so as to speed up the 3D shape acquisition method 200. Step 202 may even be strictly simultaneous with step 201: indeed, the time taken for step 205 to be performed, and thus for the image to be taken at the current pose R(tn), is generally shorter than the time taken for the transformation by path executor 22 of controller 5 and for start of actuation of the movement from the current pose to the next pose, and accordingly even if computer 4 issued its two commands (to the controller and to the 2D laser scanner) simultaneously, it would still be ensured that the image is taken at the current pose R(tn) equivalent to S(tn).

Unless the desired scanning trajectory has been completed, as checked in step 207, the steps discussed above are thereafter repeated for a next pose, as indicated by the increment of counter n in step 208. It should be understood that different methods of controlling the repetition of the steps than the method exemplified by steps 207, 208 may be equally used. It should also be understood that, if a control as that schematically shown is plainly used, then no image will be taken at the latest pose, so that an additional “fake” end point should be added to the trajectory.

The RTOS 41 run on computer 4 and the synchronization signal issued thereby guarantee that each 2D image is taken at step 205 only after the intended pose has actually been reached, and therefore guarantees that each point of the 3D point cloud that is collected at step 205 has consistent data, irrespectively of the speed of movement of the robot 3, and of any irregularities of that movement. The perfect synchronism of steps 201 and 205 is schematically illustrated by double arrow 209.

It should be noted that the end effector movement during shape acquisition need not be a translation along a direction orthogonal to the laser plane emitted by laser projector 14; rather e.g. a rotation of the laser plane may be used. It is noted that the robot movement might in principle also be used to form the length of the scan line from a laser spot, thus avoiding a sweeping mechanism or any optics of the laser projector; the scanning trajectory R(t) then becomes however rather complex, e.g. a serpentine pattern.

It is highlighted that the RTOS 41 may also be exploited during the working operation (cf. FIG. 2), in case the tooling trajectory P(t) is provided by the computer 4, to drive the working tool 12 according to the movement rather than constantly throughout the movement, e.g, to lessen the power supplied to a welding torch during deceleration and increase the power during acceleration, so as to obtain an overall constant heat output.

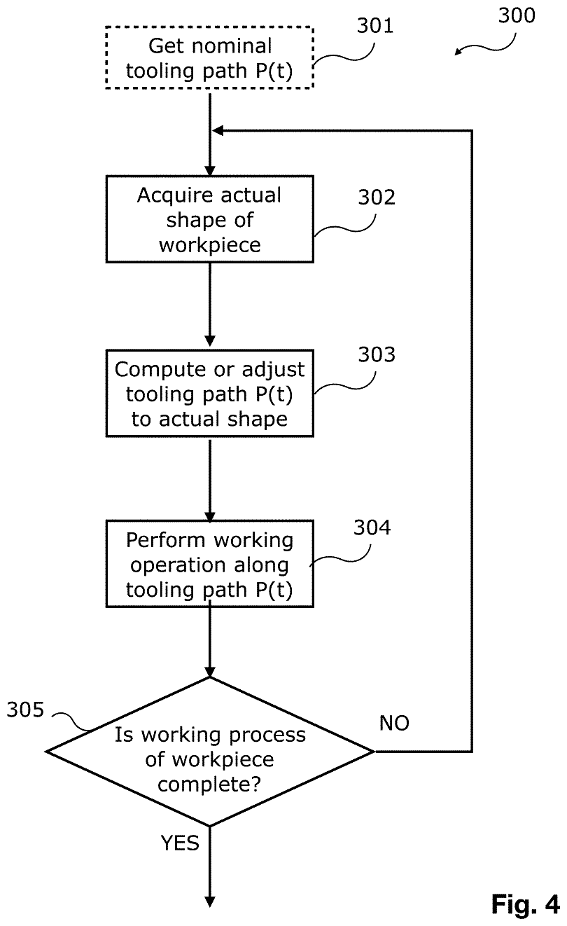

A method 300 for operating the robot apparatus of FIG. 1 according to an improved tooling path is disclosed with reference to the flowchart of FIG. 4, as well as to the previously discussed FIG. 2 and FIG. 3.

In an optional step 301 a nominal tooling path P(t) is acquired, e.g. from a memory means.

The apparatus is then operated in step 302 to acquire information about the actual shape of the workpiece 2 at working area 7. This step is performed according to the method 200 discussed above in connection with the flowchart of FIG. 3, whereby through the synchronization signal the highest time correspondence between the pose of the robot 3 and profile data acquired by the 2D laser scanner 13 is assured, so that each collected 3D point has highly consistent data and eventually, through a complete scanning operation, the workpiece 2 is virtually reconstructed in shape by the program executed in the controller 5 or on the computer 4 (or in an external computer).

Path generator 21 of controller 5 or computer 4 is then used in step 303 to compute a tooling path P(t), notably a welding path, or to adjust the nominal or other currently active tooling path, according to the workpiece shape obtained in step 302.

Then, the working operation is performed on workpiece 2 along the tooling path P(t) computed in step 303. This step is performed according to the method 100 discussed above in connection with the flowchart of FIG. 2.

Unless the desired overall working operation has been completed onto the same workpiece 2, as checked in step 305, step 302 is then returned to, to obtain an up-to-date information about the actual shape of the workpiece 2 at working area 7, before a subsequent working operation at step 304. It should be understood that different methods of controlling the repetition of the steps than the method exemplified by step 305 may be equally used.

The advantages of this method 300 of operating the robot apparatus are appreciated considering that the nominal tooling path obtained in optional step 301 may have been designed onto a sample piece, while the actual workpiece 2 may have a slightly different shape.

Moreover, one and the same workpiece 2 is often subjected to a plurality of subsequent operations, e.g. welding operations along a corresponding plurality of welding paths, e.g. because the workpiece 2 has a complex mechanical structure comprising a plurality of components. It is highly desirable to check the geometry of the workpiece 2 after each welding operation in order to precisely adjust the subsequent welding path, so as to take for example thermal dilation due to the previous welding path into account.

As another exemplary case, for performing a coating operation onto workpiece 2, several passes may be required. Each layer slightly increases the workpiece 2, thus changing its shape and the coating path necessary during the subsequent layer coating.

Very precise tooling paths are provided to the working tool 12, at each individual operation. Because the 2D laser scanner 13 is borne by the same robot arm end effector 10 that bears the working tool 12, the resolution of the reconstructed 3D shape obtained in step 302, and therefore of the tooling path defined on that shape in step 303, automatically matches the actual capability of the robot arm 9 to follow that tooling path in step 304: neither computational efforts are wasted in reconstructing the shape with a higher resolution than that at which the working will be performed, nor there is the need to interpolate further positions for the working tool 12 along a tooling path computed with a lower resolution; accordingly the accuracy is the highest possible, as is computational efficiency.

It will be appreciated that computer 4 simulates a real encoder—thus embodying what is called a “simulated encoder” herein—generating a signal suitable for the input port 16 of the 2D laser scanner 13 commonly meant to be an encoder port.

Summarizing, advantageously, a real-time update of 3D paths due to subsequent welding or other working processes is provided, as well as a highest possible resolution of 3D welding or tooling path according to robot moving and external controlling capabilities.

Maximum accuracy in profile data acquisition is achieved by the synchronization signal.

The tooling trajectory may also be further slightly adjusted “on-line” according to a feedback provided by the working tool 12, using an Automatic Voltage Control (AVC) in a manner per se well known.

Additionally, or in principle even alternatively—e.g. when the tooling path is rectilinear, the working operation may be performed along a tooling path being the same as the scanning path while the 3D shape of the workpiece is acquired. Stated in other terms, instead of performing step 302 while moving the end effector 10 on a complete scanning path covering the entire surface of the workpiece 2, and thereafter moving the end to effector 10 on a complete tooling path performing the working operation, a single movement of the end effector 10, along a combined tooling and scanning path, may be exploited both to actually perform a working operation and simultaneously to scan the workpiece 2 in order to acquire at least partial data about its shape. The acquired shape may be exploited for adjusting the tooling path for the next working operation, and/or a slight adjustment may be performed locally.

The computer 4 may be a Personal Computer, or any suitable computing apparatus that may be operated with any suitable Real Time Operating System.

While an industrial robot apparatus, notably a robot welding apparatus, has been shown and referred to above, the apparatus may also be a robot apparatus lacking any working tool, and merely intended to acquire the shape of a workpiece or object. In such a case, the robot head 10 will support the 2D laser scanner 13, but the welding torch or other tool 12 will be absent.

It shall be understood that while the shape of the workpiece has been referred to above, this term should not be construed in a limiting manner because what is actually acquired by robot apparatus 1 is the shape of the portion of the outer surface of the workpiece 2 that is exposed rather than facing the platform 6 or other supporting means (including the floor), or even the shape of a smaller area of the outer surface of the workpiece 2, that is of interest e.g. for the current working operation.

Different interchangeable working tools 12 may be provided for.

The data and/or signal connections between components may be wired connections or may also be wireless connections.

There may be additional cameras at the end effector.

Possibly, a local update of part of the tooling path (or the combined path) during a same working process may be performed: as discussed, a known Automatic Voltage Control (AVC) may be additionally provided for to slightly adjust the tooling trajectory or path (or the combined path) during the working operation.

While aspects of the invention have been described in terms of various specific to embodiments, it will be apparent to those of ordinary skill in the art that many modifications, changes, and omissions are possible without departing form the spirit and scope of the claims. In addition, unless specified otherwise herein, the order or sequence of any process or method steps may be varied or re-sequenced according to alternative embodiments. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

The term “operating”, when used in such expressions as for example “operating the computer”, “operating the working tool”, and “operating the controller”, do not necessarily refer to persons per se, but rather encompasses the concerned component following a sequence of instructions that may be stored thereinto and/or imparted by another component so as to perform the method(s) and step(s) thereof that are described and claimed herein.

The term “directly”, when used in connection with exchange of signal(s) and data between two components is meant to indicate that there is no further signal processing or data processing component in between, but encompasses that there are components that do not process the signal or data in between, such as for example wired cables and connectors.

1. An apparatus configured to perform an industrial working operation on a workpiece arranged at a working area, the apparatus comprising an anthropomorphous robot movable in space at working area, a computer, and a robot controller,
wherein the anthropomorphous robot comprises an end effector including a 2D laser scanner and a working tool which is able to perform said working operation on the workpiece,
wherein the 2D laser scanner comprises a laser projector, a camera, and an input port, and
wherein the robot controller is configured to make the robot move the end effector along a path, the working tool being selectively operable during the movement,
wherein the computer is provided with a Real-Time Operating System (RTOS) and is operatively connected to the robot controller and to the input port of the 2D laser scanner, and is configured to provide successive positional data along a scanning path to the robot controller, and a synchronization signal directly to the input port of the 2D laser scanner, thereby commanding successive scanning operations on the workpiece in synchronism with successive poses of the end effector along the scanning path, to acquire 3D shape information about the workpiece,
and in that the working tool is configured to be operated while the end effector is subsequently moved along a tooling path and/or is moved along said scanning path thus defining a combined scanning and tooling path.

2. The apparatus of claim 1, wherein the robot controller includes a path executor and a path generator, and wherein the computer is configured to provide positional data along the scanning path and/or the tooling path and/or the combined scanning and tooling path directly to the path executor bypassing the path generator.

3. The apparatus of claim 1, wherein the computer or the controller or a further processing means provided in the apparatus is configured to perform a 3D reconstruction of the shape of the workpiece after a part of or the complete scanning path and/or the combined scanning and tooling path has been followed, from scanning data and positional data as matched by the synchronization signal.

4. The apparatus of claim 3, wherein the computer or the controller or further processing means provided in the apparatus is configured to calculate or adjust the tooling path or the combined scanning and tooling path based on the 3D reconstruction of the shape of the workpiece.

5. A method for performing an industrial working operation on a workpiece arranged at a working area, through an anthropomorphous robot movable in space at working area, a computer, and a robot controller, wherein the anthropomorphous robot comprises an end effector including a 2D laser scanner and a working tool which is able to perform said working operation on the workpiece, wherein the 2D laser scanner comprises a laser projector, a camera, and an input port, and wherein the computer is operatively connected to the robot controller and to the input port of the 2D laser scanner, the method comprising the following steps:
(a) acquiring 3D shape information about the workpiece by:
(i) operating the computer with a Real-Time Operating System (RTOS) to provide successive positional data along a scanning path to the robot controller, and to provide a synchronization signal directly to the input port of the 2D laser scanner; and
(ii) operating the robot controller to move the end effector along the scanning path, thereby performing successive scanning operations in synchronism with successive poses of the end effector; and
(b) subsequently operating the robot controller to move the end effector along a tooling path different from the scanning path and operating the working tool while moving the end effector along the tooling path; or operating the working tool while moving the end effector along the scanning path, thus defining a combined scanning and tooling path.

6. The method of claim 5, comprising the step of 3D reconstructing the shape of the workpiece after a part of or the complete scanning path or combined scanning and tooling path has been followed, from scanning data and positional data as matched by the synchronization signal.

7. The method of claim 6, further comprising the step of calculating or adjusting the tooling path and/or the combined scanning and tooling path based on the 3D reconstructed shape of the workpiece.

8. The apparatus of claim 1, wherein said synchronization signal includes pulses issued simultaneously with each successive positional data.

9. The apparatus of claim 1, wherein the industrial working operation is welding, the industrial robot is a welding robot, and the working tool is a welding torch.

10. The apparatus of claim 1, wherein said workpiece comprises very thin steel layers of critical parts of turbo-machineries.

11. An apparatus configured to acquire a shape of an object arranged at a working area, the apparatus comprising an anthropomorphous robot movable in space at working area, a computer, and a robot controller,
wherein the anthropomorphous robot comprises an end effector including a 2D laser scanner,
wherein the 2D laser scanner comprises a laser projector, a camera, and an input port,
wherein the robot controller is configured to make the robot drive the 2D laser scanner along a scanning path,
wherein the computer is provided with a Real-Time Operating System (RTOS) and is operatively connected to the robot controller and to the input port of the 2D laser scanner and is configured to provide successive positional data along the scanning path to the robot controller, and a synchronization signal directly to the input port of the 2D laser scanner, thereby commanding successive scanning operations on the object in synchronism with successive poses of the end effector along the scanning path.

12. A method for acquiring 3D shape information of an object arranged at a working area, through an anthropomorphous robot movable in space at working area, a computer, and a robot controller, wherein the anthropomorphous robot comprises an end effector including a 2D laser scanner, wherein the 2D laser scanner comprises a laser projector, a camera, and an input port, and wherein the computer is operatively connected to the robot controller and to the input port of the 2D laser scanner, the method comprising the steps of:
operating the computer with a Real-Time Operating System (RTOS) to provide successive positional data along a scanning path to the robot controller, and to provide a synchronization signal directly to the input port of the 2D laser scanner, and
operating the robot controller to move the end effector along the scanning path, thereby performing successive scanning operations in synchronism with successive poses of the end effector.

13. The method of claim 5, wherein said synchronization signal includes pulses issued simultaneously with each successive positional data.

14. The method of claim 5, wherein the industrial working operation is welding, the industrial robot is a welding robot, and the working tool is a welding torch.

15. The method of claim 5, wherein said workpiece comprises very thin steel layers of critical parts of turbo-machineries.
